(19) United States
(12) Patent Application Publication
(10) Pub. No.: US 2025/0279575 A1
(43) Pub. Date: Sep. 4, 2025

(54) ANTENNA AND BASE STATION

(71) Applicant: Huawei Technologies Co., Ltd., Shenzhen (CN)

(72) Inventors: Weihong Xiao, Dongguan (CN); Liang Li, Shanghai (CN); Zhiqiang Liao, Shenzhen (CN); Jianrong Li, Shenzhen (CN); Yaohui Zhang, Shenzhen (CN)

(21) Appl. No.: 19/210,383

(22) Filed: May 16, 2025

Related U.S. Application Data
(63) Continuation of application No. PCT/CN2023/124658, filed on Oct. 16, 2023.

(30) Foreign Application Priority Data
Nov. 18, 2022 (CN) 202211448384.4

(51) Int. Cl. H01Q 1/24; H01P 5/12; H01Q 1/42; H01Q 3/36; H01Q 9/04; H01Q 9/44

(52) U.S. Cl. CPC H01Q 1/246; H01P 5/12; H01Q 1/42; H01Q 3/36; H01Q 9/0407; H01Q 9/44

(57) ABSTRACT

This application provides an antenna and a base station. The antenna includes a power splitter and a radiating element. The power splitter includes a cavity and a feeding network, and the feeding network is disposed in the cavity. The radiating element includes a radiator, a feeding part, and a protective cover. The feeding part is connected between the feeding network and the radiator, to feed the radiating element. The radiator and the protective cover are fastened together, and the feeding part is located inside the protective cover. The protective cover is fastened to the cavity, the protective cover and a surface of the cavity form an accommodating cavity, and the feeding part is located in the accommodating cavity. The accommodating cavity meets a preset protection rating. The feeding part of the radiating element is directly connected to the feeding network located in the cavity.

### CROSS-REFERENCE TO RELATED APPLICATIONS

This application is a continuation of International Application No. PCT/CN2023/124658, filed on Oct. 16, 2023, which claims priority to Chinese Patent Application No. 202211448384.4, filed on Nov. 18, 2022. The disclosures of the aforementioned applications are hereby incorporated by reference in their entireties.

### TECHNICAL FIELD

This application relates to the field of communication technologies, and specifically, to an antenna and a base station.

### BACKGROUND

As wireless communication technologies develop, there are increasingly high requirements for performance of antennas of base stations. The antennas of the base stations face problems such as how to improve radiation efficiency of the antennas, how to reduce wind loads on the antennas, and how to increase areas of antenna installation platforms. In addition, with global promotion of energy saving and low carbon, whether requirements of energy saving and low carbon can be met also needs to be considered during development of technologies of the antennas of the base stations. How to reduce carbon emissions in the antenna field by changing sizes of the antennas of the base stations is also crucial.

### SUMMARY

This application provides an antenna and a base station, to improve radiation efficiency of the antenna, save electrical energy, and further reduce carbon emissions. In addition, the antenna in the solution does not need to be provided with a radome, simplifying a structure of the antenna and helping reduce a wind load on the antenna.

According to a first aspect, this application provides an antenna. The antenna includes a power splitter and a radiating element. The power splitter includes a cavity and a feeding network. The feeding network is disposed in the cavity, so that the cavity can protect the feeding network. The radiating element includes a radiator, a feeding part, and a protective cover. Specifically, the radiator is configured to radiate and receive signals. The feeding part is connected between the feeding network and the radiator, to feed the radiating element. The radiator and the protective cover are fastened together, and the feeding part is located inside the protective cover. The protective cover is fastened to the cavity, the protective cover and a surface of the cavity form a closed accommodating cavity, and the feeding part is located in the accommodating cavity. The feeding part of the radiating element is directly connected to the feeding network located in the cavity. Therefore, cascading of coaxial cables in the antenna can be reduced, helping implement efficient radiation. Further, when being required to ensure same coverage signal strength, the antenna requires less input power, saving electrical energy and further reducing carbon emissions.

In a specific technical solution, the antenna may not include a radome. For the antenna in the solution, the accommodating cavity can protect the feeding part, and the cavity can protect the feeding network. Therefore, the antenna may not be provided with a radome. According to the solution, a structure of the antenna is simplified, helping reduce a wind load on the antenna, and implementing that the antenna is unlikely limited by space at an antenna installation platform. Under same conditions, a size of the antenna can be relatively increased based on a requirement, that is, a quantity of radiating elements of the antenna can be increased, to enhance performance benefits of the antenna. In addition, costs of the antenna can be reduced.

When the accommodating cavity is specifically provided, the accommodating cavity meets a preset protection rating. In other words, the accommodating cavity has specific waterproof and dustproof capabilities, so that the feeding part can be protected in the accommodating cavity.

In a specific technical solution, the protection rating of the accommodating cavity is equal to or higher than IP24. Therefore, the accommodating cavity provides good protection for the feeding part of the antenna. In this case, internal lines can still be effectively protected without protection provided by a radome.

The antenna may further include a balun. The balun is connected between the radiator and the cavity and configured to ground the radiator. The balun is alternatively located in the accommodating cavity, so that the accommodating cavity can also provide protection for the balun.

In a further technical solution, the power splitter further includes a phase shifting apparatus, which is configured to change a phase of a signal to be radiated by the antenna. The phase shifting apparatus is specifically disposed in the cavity. Therefore, the cavity can protect the phase shifting apparatus. The phase shifting apparatus is disposed in the cavity.

During specific implementation of fastening the radiator and the protective cover together, the radiator and the protective cover may alternatively be an integrally formed structure. In this way, the radiator and the protective cover have a reliable fastening structure in between and are well sealed.

A specific structure of the radiator is not limited in this application. For example, the radiator may be a patch radiator, or may be a dipole radiator. The technical solutions provided in this application are applicable to various types of radiators.

In a specific technical solution, the radiator is at least partially located outside the protective cover. For a purpose of protecting the radiator, a surface of a region that is of the radiator and that is located outside the protective cover is coated with a protective layer. In this way, the entire radiator can be protected.

For a purpose of connecting the protective cover to the cavity, the protective cover may have a connecting portion, and the protective cover is fastened to the cavity by the connecting portion. In this way, reliability of connection between the protective cover and the cavity is improved.

In a technical solution, a sealing piece is further disposed between the connecting portion and the cavity. According to the solution, a sealing level of the accommodating cavity formed by the protective cover and the surface of the cavity can be further improved.

In a specific technical solution, the connecting portion is a first protruding edge of the protective cover, the cavity has a second protruding edge, and the first protruding edge and the second protruding edge are fastened together. This solution helps simplify a manner of connection between the protective cover and the cavity, and improve strength of connection between the protective cover and the cavity.

The first protruding edge and the second protruding edge are connected by screws or bolts. In this way, the protective cover can be detachably connected to the cavity, and mounting and detaching processes are simple.

When the radiating element is a dual-polarized radiating element, the feeding network includes a first feeder and a second feeder, and the feeding part includes a first feeding portion and a second feeding portion. The cavity includes a first through-hole and a second through-hole, the first through-hole and the second through-hole are spaced a preset distance apart, the first feeder is connected to the first feeding portion through the first through-hole, and the second feeder is connected to the second feeding portion through the second through-hole. In the solution, the first through-hole and the second through-hole are spaced the preset distance apart. Therefore, it can be considered that there is a ground plane between the first through-hole and the second through-hole. As such, transmission paths of signals of the radiating element in two polarization directions are highly isolated, reducing mutual crosstalk.

The antenna in the technical solution of this application further includes a reflector plate. The reflector plate is mounted between the cavity and the radiating element, and the reflector plate has a hollow-out structure. In this way, a wind load on the reflector plate is reduced, and therefore, a wind load on the entire antenna is reduced.

For a purpose of mounting the reflector plate on the cavity, the reflector plate may be connected to the cavity by an insulation connecting piece. In this way, interference to antenna signals is reduced.

According to a second aspect, this application further provides a base station. The base station includes a mounting bracket and the antenna according to the first aspect. The antenna is mounted on the mounting bracket. The solution aims to improve radiation efficiency of the antenna of the base station, save electrical energy, and further reduce carbon emissions.

### BRIEF DESCRIPTION OF THE DRAWINGS

FIG. 1 is a diagram of an architecture of a communication system that is applicable to an embodiment of this application;

FIG. 2 is a diagram of a possible structure of a base station according to an embodiment of this application;

FIG. 3 is a diagram of a possible composition of an antenna according to an embodiment of this application;

FIG. 4 is a lateral view of a structure of an antenna according to an embodiment of this application;

FIG. 5 is a diagram of a structure of a radiating element according to an embodiment of this application;

FIG. 6 is an exploded view of a structure of an antenna according to an embodiment of this application;

FIG. 7 is a lateral view of another structure of an antenna according to an embodiment of this application; and

FIG. 8 is a top view of a structure of an antenna according to an embodiment of this application.

Reference numerals:
1—antenna;
11—power splitter;
111—cavity;
1111—second protruding edge;
1112—first through-hole;
1113—second through-hole;
112—feeding network;
12—radiating element;
121—radiator;
122—feeding part;
123—protective cover;
1231—connecting portion;
124—balun;
13—reflector plate;
131—hollow-out structure;
2—mounting bracket;
3—antenna adjustment support;
4—radio frequency processing unit;
5—baseband processing unit;
6—cable.

### DETAILED DESCRIPTION OF ILLUSTRATIVE EMBODIMENTS

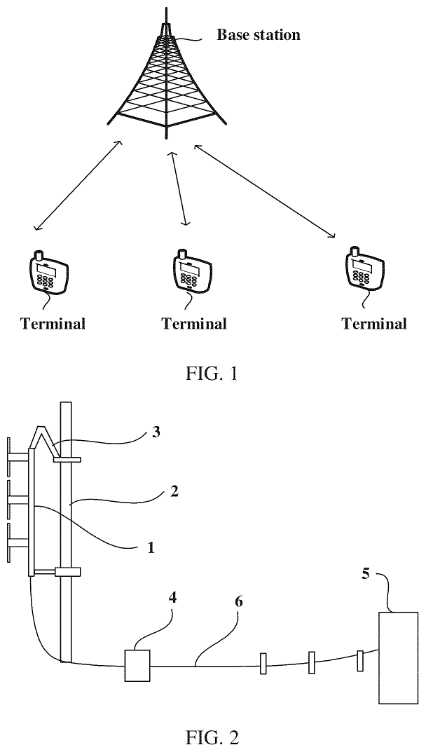

To facilitate understanding of an antenna and a communication system provided in embodiments of this application, the following describes an application scenario of the antenna and the communication system. FIG. 1 is a diagram of an example architecture of a communication system that is applicable to an embodiment of this application. As shown in FIG. 1, the communication system may be an antenna system of a base station. The application scenario may include a base station and a terminal. Wireless communication may be implemented between the base station and the terminal. The base station may be located in a base station subsystem (BBS), a UMTS terrestrial radio access network (UTRAN), or an evolved universal terrestrial radio access network (E-UTRAN), and is configured to cover cells with radio signals, to implement communication between terminal devices and a radio network. Specifically, the base station may be a base transceiver station (BTS) in a global system for mobile communication (GSM) or in a code division multiple access (CDMA) system, or may be a NodeB (NB) in a wideband code division multiple access (WCDMA) system, or may be an evolved NodeB (eNB or eNodeB) in a long term evolution (LTE) system, or may be a radio controller in a cloud radio access network (CRAN) scenario. Alternatively, the base station may be a relay station, an access point, a vehicle-mounted device, a wearable device, a gNode (gNodeB or gNB) in a new radio (NR) system, a base station in a future evolved network, or the like. This is not limited in embodiments of this application.

FIG. 2 is a diagram of a possible structure of a base station. The base station may usually include structures such as an antenna 1, a mounting bracket 2, and an antenna adjustment support 3. The antenna 1 may be mounted on the mounting bracket 2 by use of the antenna adjustment support 3, to help the antenna 1 receive or transmit signals. Certainly, the embodiment shown in FIG. 2 is merely used as an optional implementation. During specific implementation, the antenna and the base station in this embodiment of this application may be different from those in the embodiment shown in FIG. 2. This is not limited in this application.

In addition, the base station may further include a radio frequency processing unit 4 and a baseband processing unit 5. For example, the radio frequency processing unit 4 may be configured to perform frequency selection, amplification, and down-conversion on signals received by the antenna 1, convert the processed signals into intermediate frequency signals or baseband signals, and send the intermediate frequency signals or baseband signals to the baseband processing unit 5; or the radio frequency processing unit 4 is configured to perform up-conversion and amplification on the baseband processing unit 5 or intermediate frequency signals, and the antenna 1 converts the processed signals into electromagnetic waves and sends out the electromagnetic waves. The baseband processing unit 5 may be connected to a feeding network of the antenna 1 by the radio frequency processing unit 4. In some implementations, the radio frequency processing unit 4 may also be referred to as a remote radio unit (RRU), or may be a radio frequency module in an active antenna unit (AAU); and the baseband processing unit 5 may also be referred to as a baseband unit (BBU).

In a possible embodiment, as shown in FIG. 2, the radio frequency processing unit 4 may be disposed together with the antenna 1, and the baseband processing unit 5 is located at a remote end of the antenna 1. In some other embodiments, the radio frequency processing unit 4 and the baseband processing unit 5 may be alternatively both located at a remote end of the antenna 1. The radio frequency processing unit 4 and the baseband processing unit 5 may be connected by a cable 6.

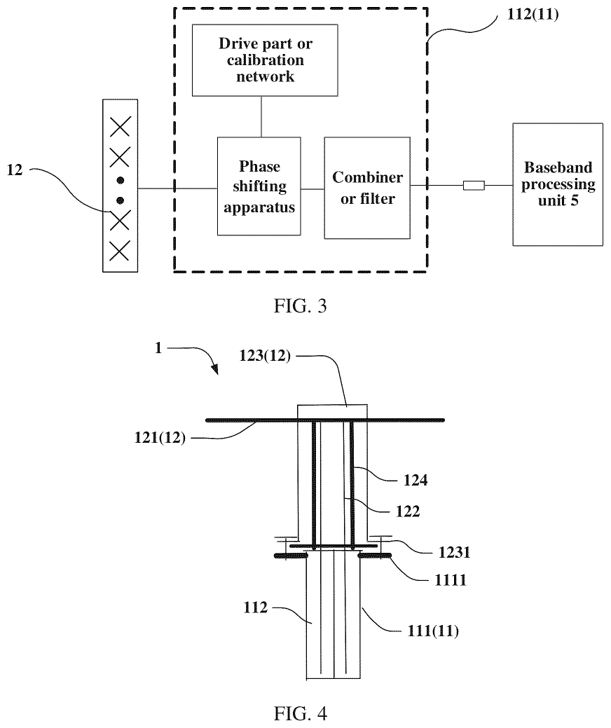

FIG. 3 is a diagram of a possible composition of an antenna according to an embodiment of this application. FIG. 4 is a lateral view of a structure of an antenna according to an embodiment of this application. As shown in FIG. 2, FIG. 3, and FIG. 4, the antenna 1 includes a power splitter 11 and a radiating element 12. The radiating element 12 may also be referred to as an antenna dipole, a dipole, or the like, and can effectively send or receive antenna signals. In the antenna 1, different radiating elements 12 may operate on a same frequency or different frequencies. The power splitter 11 includes a cavity 111 and a feeding network 112. The feeding network 112 is disposed in the cavity 111, so that the cavity 111 can protect the feeding network. The radiating element 12 is connected to the feeding network 112. The feeding network 112 is configured to feed the radiating element 12. Specifically, the feeding network 112 is usually formed by a controlled impedance transmission line. The feeding network 112 may feed signals to the radiating element 12 at a specific amplitude and a specific phase, or send signals received by the radiating element 12 to the baseband processing unit of the base station at a specific amplitude and a specific phase. Specifically, in some implementations, the feeding network 112 may be configured to implement different beam radiation directions, or may be connected to a calibration network to obtain a calibration signal required by a system. Some modules configured to expand performance may be further disposed in the feeding network 112. For example, a combiner may be configured to combine signals of different frequencies into one channel of signals for transmission by the radiating element 12; or when being used in a reverse direction, the combiner may be configured to split, based on different frequencies, signals received by the radiating element 12 into a plurality of channels of signals, and transmit the signals to the baseband processing unit for processing. For another example, a filter is configured to filter out an interfering signal. In a specific embodiment, a plurality of radiating elements 12 may form a radiating element array and work in a form of an array.

FIG. 5 is a diagram of a structure of a radiating element according to an embodiment of this application. As shown in FIG. 4 and FIG. 5, in this embodiment of this application, the radiating element 12 of the antenna 1 includes a radiator 121, a feeding part 122, and a protective cover 123. The feeding part 122 is connected between the feeding network 112 and the radiator 121. Specifically, one end of the feeding part 122 may be connected to the feeding network 112, and the other end may be connected to the radiator 121. The feeding part 122 may be specifically in a form of a conducting wire. The radiator 121 and the protective cover 123 are fastened together, forming a whole. The feeding part 122 is located inside the protective cover 123. Specifically, the protective cover 123 is fastened to the cavity 111, so that the radiating element 12 is fastened to the cavity 111. In addition, the protective cover 123 and a surface of the cavity 111 form an accommodating cavity, so that the feeding part 122 is located in the accommodating cavity. In this embodiment, the feeding part 122 of the radiating element 12 is directly connected to the feeding network 112 located in the cavity 111. Therefore, cascading of coaxial cables in the antenna 1 can be reduced, helping implement efficient radiation. Further, when being required to ensure same coverage signal strength, the antenna 1 requires less input power, saving electrical energy and further reducing carbon emissions.

A line, a circuit interface, or the like that is in the antenna 1 and that implements electrical connection has a high requirement for dust and water resistance, and therefore needs to be protected. In the solution, the feeding part 122 of each radiating element 12 can be protected by the accommodating cavity, and the feeding network 112 can be protected by the cavity. In this case, the feeding part 122 and the feeding network 112 can be both separately protected. Therefore, the radiating element 12 may not include a radome. In this way, according to the solution, the structure of the antenna 1 is simplified, helping reduce a wind load on the antenna 1, and implementing that the antenna 1 is unlikely limited by space at an antenna installation platform. Under same conditions, a size of the antenna 1 can be relatively increased based on a requirement, that is, a quantity of radiating elements 12 of the antenna 1 can be increased, to enhance performance benefits of the antenna 1. Especially for an area with large space and strong winds such as a sea area, the technical solutions in this application are of greater significance. In addition, because the antenna in this embodiment of this application does not have a radome, a weight and costs can also be reduced.

When the accommodating cavity is specifically formed, the accommodating cavity meets a preset protection rating. Therefore, the accommodating cavity can resist dust and water to some extent, and the feeding part 122 can be protected in the accommodating cavity.

In a specific embodiment, the preset protection rating that the accommodating cavity meets may be specifically an Ingress Protection (IP) rating. An IP rating is a rating of protection provided by an enclosure of electrical equipment against ingress of foreign objects, and is specified in the International Electrotechnical Commission standard IEC 60529. In the standard, for protection provided by an enclosure of electrical equipment against foreign objects, an IP rating is in a format of IPXX, where XX is two Arabic numerals. The first characteristic numeral indicates a rating of protection against contact and foreign objects. Specifically, the first characteristic numeral being o indicates “non-protected: no special protection”; the first characteristic numeral being 1 indicates “protected against an object greater than 50 mm: protected against accidental touch of a part inside electrical equipment by a human body”; the first characteristic numeral being 2 indicates “protected against an object greater than 12 mm: protected against touch of a part inside electrical equipment by a finger”; the first characteristic numeral being 3 indicates “protected against an object greater than 2.5 mm: protected against a tool, a wire, or an object greater than 2.5 mm in diameter”; the first characteristic numeral being 4 indicates “protected against an object greater than 1.0 mm: protected against a mosquito, an insect, or an object greater than 1.0 mm in diameter”; the first characteristic numeral being 5 indicates “dust-protected: ingress of dust is not totally prevented, but dust shall not penetrate in a quantity to interfere with satisfactory operation of the equipment”; and the first characteristic numeral being 6 indicates “dust-tight: no ingress of dust”. The second characteristic numeral indicates a rating of protection against water. Specifically, the second characteristic numeral being o indicates “non-protected: no special protection”; the second characteristic numeral being 1 indicates “protected against drops of water: protected against vertically falling drops of water”; the second characteristic numeral being 2 indicates “protected against water drops when tilted up to 15 degrees: protected against water drops when electrical equipment is tilted up to 15 degrees”; the second characteristic numeral being 3 indicates “protected against spraying water: protected against rain or sprays of water up to 50 degrees from the vertical”; the second characteristic numeral being 4 indicates “protected against splashing water: protected against water splashed from all directions”; the second characteristic numeral being 5 indicates “protected against water from heavy seas: protected against water from heavy seas or water projected rapidly in jets”; the second characteristic numeral being 6 indicates “protected against water from heavy seas: electrical equipment can still operate properly when being immersed in water under specific conditions of time or water pressure”; the second characteristic numeral being 7 indicates “protected against immersion in water: electrical equipment can still operate properly when sinking in water indefinitely under specific conditions of water pressure”; and the second characteristic numeral being 8 indicates “protected against effects of sinking”.

The protection rating of the accommodating cavity formed by the protective cover 123 and the surface of the cavity 111 may be higher than or equal to IP24. Therefore, the accommodating cavity provides good protection for the feeding part 122 of the antenna. In this case, internal lines can still be effectively protected without protection provided by a radome. In a specific embodiment, the protection rating of the accommodating cavity may be IP34, IP44, IP45, IP46, IP55, IP56, IP57, IP64, IP66, IP67, or the like.

In some embodiments, as shown in FIG. 4, the antenna 1 further includes a balun 124. The balun 124 is connected between the radiator 121 and the ground and configured to ground the radiator 121. Specifically, one end of the balun 124 may be connected to the radiator 121, and the other end may be connected to the surface of the cavity 111. In other words, the cavity 111 may be used as the ground for the antenna. This is not specifically limited in this application. Optionally, the balun 124 may be alternatively located in the accommodating cavity, so that the accommodating cavity can also protect the balun 124 and an interface between the balun 124 and another line.

In some embodiments, the power splitter 11 may further include a phase shifting apparatus. The phase shifting apparatus is configured to change a phase of a signal to be radiated by the antenna. The phase shifting apparatus is specifically disposed in the cavity 111. Therefore, the cavity 111 can protect the phase shifting apparatus.

During specific implementation of fastening the radiator 121 and the protective cover 123 together, the radiator 121 and the protective cover 123 may be an integrally formed structure. In this way, the radiator 121 and the protective cover 123 have a reliable fastening structure in between and are well sealed. Specifically, when the radiator 121 is made of a metal material and the protective cover 123 is made of an insulating material such as plastic, the radiator 121 and the protective cover 123 may be produced by using an injection molding process. Certainly, in another embodiment, the radiator 121 and the protective cover 123 may be alternatively fastened together by using a process such as sticking, hot melt joining, or detachable joining. This is not limited in this application.

At least part of a structure of the radiator 121 is located outside the protective cover 123. A surface of a region that is of the radiator 121 and that is located outside the protective cover 123 is coated with a protective layer. Therefore, the radiator 121 can be protected against corrosion, water, and the like. In a specific embodiment, the protective layer may be formed by coating a surface of the radiator 121, for example, coating the surface with polyester paint or the like. Alternatively, in another embodiment, a protective layer may be pasted, sleeved, or the like on a surface of the radiator 121. This is not limited in this application.

A specific structure of the radiator 121 is not limited in this application. For example, the radiator 121 may be a patch radiator, or may be a dipole radiator. Both may use the technical solutions in this application.

In some implementations, for a purpose of fastening the protective cover 123 to the cavity 111, the protective cover 123 may have a connecting portion 1231, and the connecting portion 1231 is fastened to the cavity 111. In the solution, that the protective cover 123 has the connecting portion 1231 helps simplify a manner of connection between the protective cover 123 and the cavity 111. In addition, a sealing piece may be disposed between the connecting portion 1231 and the cavity 111, further improving a sealing level of the accommodating cavity formed by the protective cover 123 and the surface of the cavity 111. Specifically, the sealing piece may be a sealing ring, a sealing rubber strip, or the like. This is not specifically limited in this application.

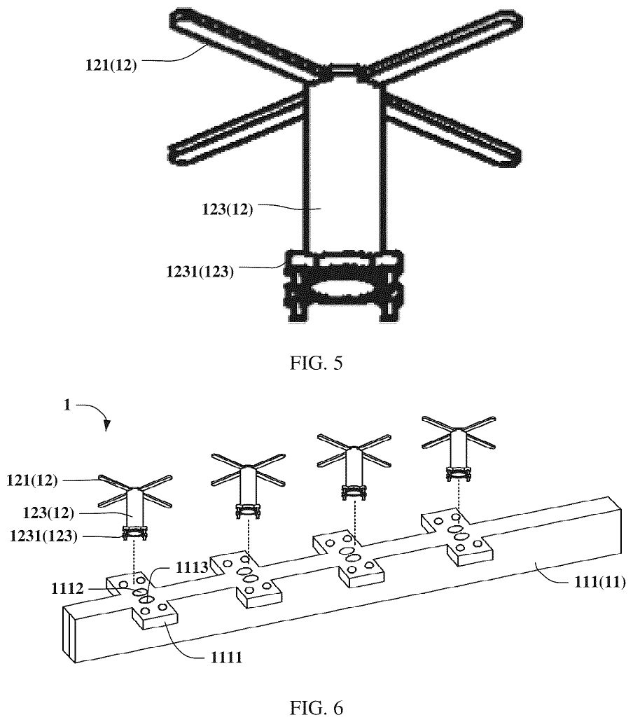

FIG. 6 is an exploded view of a structure of an antenna according to an embodiment of this application. With reference to FIG. 4 and FIG. 6, in some implementations, the connecting portion 1231 is a first protruding edge of the protective cover 123. In other words, the protective cover 123 has the first protruding edge. The first protruding edge serves as the connecting portion 1231 and is configured to be fastened to the cavity 111. Correspondingly, the cavity 111 has a second protruding edge 1111. The first protruding edge and the second protruding edge 1111 are fastened together. This solution helps simplify a manner of connection between the protective cover 123 and the cavity 111. For example, a through-hole may be provided in the first protruding edge, a through-hole may also be provided in the second protruding edge 1111, and a bolt passes through the through-hole in the first protruding edge and the through-hole in the second protruding edge 1111 to connect the first protruding edge and the second protruding edge 1111. Alternatively, a through-hole may be provided in the first protruding edge, a threaded hole may be provided in the second protruding edge 1111, and a screw passes through the through-hole in the first protruding edge and screws into the threaded hole, simplifying the structure of the antenna 1 and reducing a volume of the antenna 1. Certainly, the protective cover 123 may be alternatively connected to the cavity 111 in another manner of connection, for example, through snap-fitting. This is not limited in this application.

Still with reference to FIG. 4, in some implementations, the cavity 111 includes a first through-hole 1112 and a second through-hole 1113. The first through-hole 1112 and the second through-hole 1113 are spaced a preset distance apart. In other words, the first through-hole 1112 and the second through-hole 1113 do not communicate with each other. When the radiating element 12 is a dual-polarized radiating element, the feeding network 112 may include a first feeder and a second feeder, and the feeding part 122 of the radiating element 12 includes a first feeding portion and a second feeding portion. The first feeder is connected to the first feeding portion through the first through-hole 1112, and the second feeder is connected to the second feeding portion through the second through-hole 1113. In a specific embodiment, the first feeding portion and the second feeding portion may alternatively be of a wire-shaped structure. A point at which the first feeder and the first feeding portion are connected may be located in the accommodating cavity or in the cavity 111. Likewise, a point at which the second feeder and the second feeding portion are connected may be located in the accommodating cavity or in the cavity 111. This is not limited in this application. In the solution, the first through-hole 1112 and the second through-hole 1113 are spaced the preset distance apart. Therefore, it can be considered that there is a ground plane between the first through-hole 1112 and the second through-hole 1113. As such, transmission paths of signals of the radiating element 12 in two polarization directions are highly isolated, reducing mutual crosstalk.

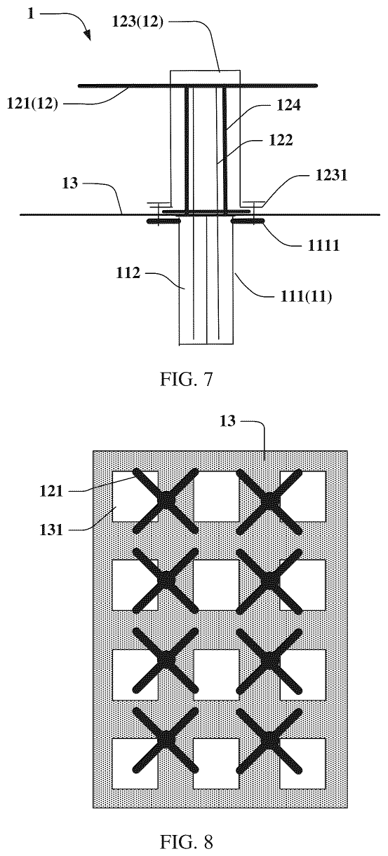

Further, FIG. 7 is a lateral view of another structure of an antenna according to an embodiment of this application. As shown in FIG. 7, in some embodiments, the antenna 1 further includes a reflector plate 13. The reflector plate 13 is mounted between the cavity 111 and the radiating element 12. The reflector plate 13 may also be referred to as a base plate, an antenna panel, a reflective surface, or the like, and may be made of a metal material. When the antenna 1 receives signals, the reflector plate 13 may reflect the antenna signals to a target coverage area. When the antenna 1 transmits signals, the reflector plate 13 may reflect signals transmitted to the reflector plate 13. The radiating element 12 is usually placed on a surface of a side of the reflector plate 13. This can not only greatly enhance the antenna's capabilities of receiving or transmitting signals, but also block and shield interference caused to the antenna's reception of signals by other electric waves that are from a back of the reflector plate 13 (in this application, the back of the reflector plate 13 is a side that is away from the side that is of the reflector plate 13 and on which the radiating element 12 is disposed).

FIG. 8 is a top view of a structure of an antenna according to an embodiment of this application. As shown in FIG. 8, the reflector plate 13 may specifically have a hollow-out structure 131. In this way, a wind load on the reflector plate 13 is reduced, and therefore, a wind load on the entire antenna 1 is reduced. This helps increase the size of the antenna 1 and increase a quantity of radiating elements 12 of the antenna 1, to enhance performance benefits of the antenna 1.

When the reflector plate is specifically disposed, the reflector plate 13 may be connected to the cavity 111 by an insulation connecting piece. In this way, interference to antenna signals is reduced. Specifically, the insulation connecting piece may be a flexible piece. The reflector plate 13 is tied to the cavity 111 by the flexible piece, to simplify a mounting structure. In addition, there is no need to damage a structure of the cavity 111. For a purpose of facilitating the tying by use of the flexible piece, a hook may be disposed on an outer wall of the cavity 111, so that the flexible piece is hung on the hook.

In a specific embodiment, the reflector plate may further have a hole. A structure such as the balun 124 of the dipole may be connected to the power splitter 11 through the hole.

Terms used in the foregoing embodiments are merely for a purpose of describing specific embodiments, but are not intended to limit this application. As used in the specification and the appended claims of this application, singular expressions “one”, “a/an”, “the”, “the foregoing”, and “this” are intended to also include expressions such as “one or more”, unless otherwise explicitly indicated in the context.

Any embodiment in which there is an expression such as “specific”, “specifically disposed”, or “specifically designed” in this application is an optional embodiment. In other words, the embodiment is a possible specific embodiment based on an inventive concept of this application, but another possible embodiment is further included.

Reference to “an embodiment”, “a specific embodiment”, or the like described in this application means that one or more embodiments of this application include a specific feature, structure, or characteristic described with reference to the embodiment. The terms “include”, “have”, and their variants all mean “include but are not limited to”, unless otherwise specifically emphasized in another manner.

The foregoing embodiments may be independent embodiments, or may be combined. For example, technical features in at least two of embodiments are combined to form a new embodiment. This is not limited in this application.

It is clear that a person skilled in the art can make various modifications and variations to this application without departing from the protection scope of this application. In this way, this application is intended to cover these modifications and variations of this application provided that they fall within the scope defined by the claims of this application and their equivalent technologies.

What is claimed is:

1. An antenna, comprising a power splitter and a radiating element, wherein the power splitter comprises a cavity and a feeding network, the feeding network is disposed in the cavity, the radiating element comprises a radiator, a feeding part, and a protective cover, and the feeding part is connected between the feeding network and the radiator; and
the radiator and the protective cover are fastened together, the protective cover is fastened to the cavity, the protective cover and a surface of the cavity form a closed accommodating cavity, and the feeding part is located in the accommodating cavity.

2. The antenna according to claim 1, wherein the antenna does not comprise a radome.

3. The antenna according to claim 1, wherein the accommodating cavity meets the preset protection rating.

4. The antenna according to claim 3, wherein the preset protection rating of the accommodating cavity is equal to or higher than IP24.

5. The antenna according to claim 1, further comprising a balun, wherein the balun is connected between the radiator and the cavity and configured to ground the radiator, and the balun is located in the accommodating cavity.

6. The antenna according to claim 1, wherein the power splitter further comprises a phase shifting apparatus, and the phase shifting apparatus is disposed in the cavity.

7. The antenna according to claim 1, wherein the radiator and the protective cover are an integrally formed structure.

8. The antenna according to claim 1, wherein the radiator is a patch radiator or a dipole radiator.

9. The antenna according to claim 1, wherein the radiator is at least partially located outside the protective cover, and a surface of a region that is of the radiator and that is located outside the protective cover is coated with a protective layer.

10. The antenna according to claim 1, wherein the protective cover has a connecting portion, and the protective cover is fastened to the cavity by the connecting portion.

11. The antenna according to claim 10, wherein a sealing piece is disposed between the connecting portion and the cavity.

12. The antenna according to claim 10, wherein the connecting portion is a first protruding edge of the protective cover, the cavity has a second protruding edge, and the first protruding edge and the second protruding edge are fastened together.

13. The antenna according to claim 1, wherein the feeding network comprises a first feeder and a second feeder, the radiating element is a dual-polarized radiating element, the feeding part comprises a first feeding portion and a second feeding portion, the cavity comprises a first through-hole and a second through-hole, the first through-hole and the second through-hole are spaced a preset distance apart, the first feeder is connected to the first feeding portion through the first through-hole, and the second feeder is connected to the second feeding portion through the second through-hole.

14. The antenna according to claim 1, further comprising a reflector plate, wherein the reflector plate is mounted between the cavity and the radiating element, and the reflector plate has a hollow-out structure.

15. The antenna according to claim 14, wherein the reflector plate is connected to the cavity by an insulation connecting piece.

16. A base station, comprising a mounting bracket and an antenna, wherein the antenna is mounted on the mounting bracket;
the antenna comprises a power splitter and a radiating element, wherein the power splitter comprises a cavity and a feeding network, the feeding network is disposed in the cavity, the radiating element comprises a radiator, a feeding part, and a protective cover, and the feeding part is connected between the feeding network and the radiator; and
the radiator and the protective cover are fastened together, the protective cover is fastened to the cavity, the protective cover and a surface of the cavity form a closed accommodating cavity, and the feeding part is located in the accommodating cavity.

17. The antenna according to claim 16, wherein the antenna does not comprise a radome.

18. The antenna according to claim 16, wherein the accommodating cavity meets the preset protection rating.

19. The antenna according to claim 18, wherein the preset protection rating of the accommodating cavity is equal to or higher than IP24.

20. The antenna according to claim 19, further comprising a balun, wherein the balun is connected between the radiator and the cavity and configured to ground the radiator, and the balun is located in the accommodating cavity.
